(19) United States
(12) Patent Application Publication
(10) Pub. No.: US 2002/0050162 A1
(43) Pub. Date: May 2, 2002

(54) Knock locating method

(76) Inventors: Michel Castagne, Palaiseau (FR); Stephane Henriot, Malmaison (FR); Gaetan Monnier, Carrieres Sous Poissy (FR)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/984,832

(22) Filed: Oct. 31, 2001

(30) Foreign Application Priority Data
Oct. 31, 2000 (FR) 00/14085

(51) Int. Cl. G01L 23/22

(52) U.S. Cl. 73/35.12

(57) ABSTRACT

The present invention relates to a method of locating the source of a knock, or more generally of a high-gradient self-ignition, appearing in a combustion chamber of an engine. According to the method, several pressure detectors are used, the pressure waves received by the detectors are recorded, the distance differences between the source of the knock and the various detectors are determined and the spatial location of the knock source in the chamber is deduced therefrom.

### FIELD OF THE INVENTION

The present invention relates to a method for analysing the origin of knocks in a combustion engine, generally a spark-ignition engine. The object of this method is to allow, from the measurement of a parameter relative to combustion, for example the pressure in the combustion chamber, to locate the starting point of a knock during each engine cycle and on each cylinder. The present invention thus allows statistical evaluation of the commonest points of appearance of a knock for predetermined engine configurations and combustion parameters.

### BACKGROUND OF THE INVENTION

It can be reminded that the term <<knock>> refers to a more or less sudden self-ignition of part of the air-fuel charge before the arrival of the flame front resulting from ignition by the plug. This unwanted self-ignition, in the case of spark-ignition engines, leads to a local pressure increase followed by a vibration of the gas mass at the natural frequencies of the combustion chamber. Such a phenomenon can generate destructive effects if it is intense and repetitive.

In general, the term <<knock>> used here can refer to an unwanted self-ignition as in the case of spark-ignition engines, or to a a wanted self-ignition as in the case of diesel engines or engines having sparkless controlled self-ignition combustion phases.

There are well-known systems for knock detection which work according to the principle of accelerometric measurement or ionization measurement. However, these systems provide no answer concerning the precise point of appearance of knocks.

Publications SAE 950,681 and SAE 2000-01-0252 also describe various methods for locating knocks by means of optical sensors.

For engine research and tuning purposes, in particular in the case of spark-ignition engines, it is necessary to be able to determine the zone of appearance of knocks in order to study the influential geometric factors and their coupling with combustion adjustment parameters. This can allow to optimize the design of combustion chambers and to use adjustment parameters in order to delay as much as possible the appearance of knock and to get the most out of the energy supplied by the combustion of the air-fuel mixture in the working phases where knock may occur, i.e. mainly at high load. Optimization of the engine as regards knock can also have favourable consequences at low load, by allowing for example to use a higher compression ratio, which leads to a higher combustion efficiency.

In the case of diesel and controlled self-ignition engines, locating the ignition point can allow to better optimize combustion and engine running.

### SUMMARY OF THE INVENTION

The present invention thus relates to a method of locating the source of a high-gradient self-ignition, mainly a knock, appearing in a combustion chamber of an engine. According to the method, the following stages are carried out:

arranging several pressure detectors in the combustion chamber,

recording the pressure waves received by the detectors,

determining the velocity of propagation of the pressure waves in the chamber,

measuring the pressure wave arrival lag between the various detectors,

determining the distance differences between the knock source and the various detectors, and deducing therefrom the spatial location of the knock source in the chamber.

The pressure detectors can be arranged in the joint plane of the cylinder head.

At least one of the detectors can be outside the plane defined by the other detectors.

In the case where the knock appearance occurs in a known plane, three detectors can be used.

Preferably, at least four detectors can be used.

The method according to the invention can be applied for locating the ignition point in the case of other combustion types, such as diesel type combustion by charge compression, homogeneous or heterogeneous, or controlled self-ignition combustion, for example by the controlled presence in the chamber of a high proportion of burnt gas from the previous cycle.

### BRIEF DESCRIPTION OF THE DRAWINGS

Other features and advantages of the present invention will be clear from reading the description hereafter of non-limitative examples, with reference to the accompanying drawings wherein:

FIGS. 1a, 1b and 1c illustrate the recording and the processing of the pressure waves measured,

FIG. 2 diagrammatically shows the position of the detectors in the combustion chamber.

### DETAILED DESCRIPTION

The proposed locating principle is based on a goniometric process. It rests on measurements of one of the parameters relative to the combustion in the chamber, for example the pressure, by means of several detectors (at least four so as to have an acceptable locating accuracy in the space of the chamber, at least three if locating is limited to a predetermined plane) distributed at various points of the combustion chamber.

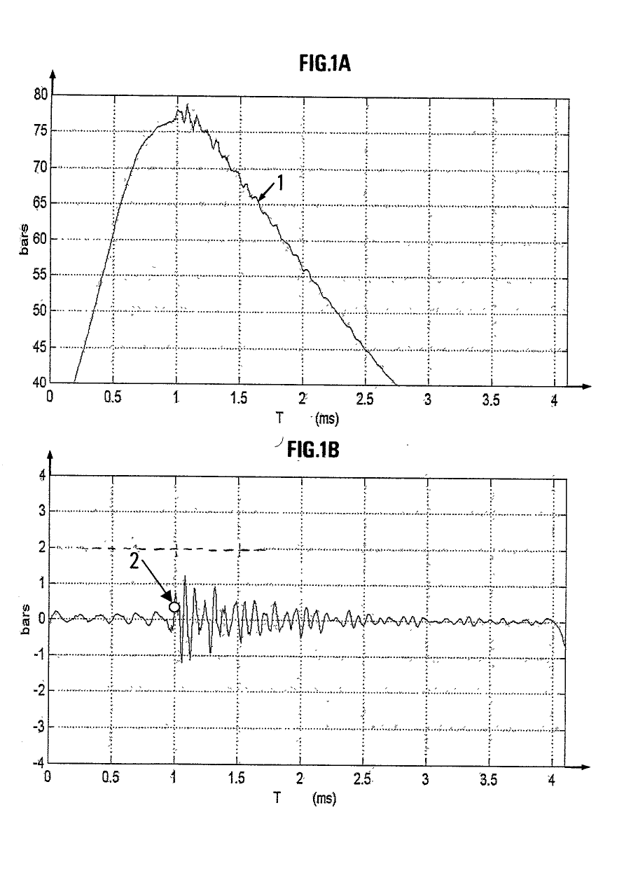

The graph of FIG. 1a shows a signal 1 recorded by one of the pressure detectors (abscissa: the time in millisecond; ordinate: the pressure in bar).

From these pressure wave measurements acquired at high frequency and simultaneously, the time 2 of arrival of the wave generated by the knock on each detector is determined for example by means of a pressure signal threshold method. This signal is preferably filtered, for example by removing the low-frequency components, for example <3 kHz, and the high-frequency components, for example >50 kHz, and by keeping only the frequency zone corresponding to the knock wave (shown in FIG. 1b).

The mean velocity of propagation (celerity C) of the pressure waves in the chamber is determined in parallel by means of a simplified calculation, for example from a measurement of the pressure at the time of appearance of the knock on a reference detector:

C=γ×.r×T,

with T=Pressure×Volume/admitted mass/r, where γ is determined by a simplified law as a function of temperature T.

The celerity can also be determined from the natural frequencies of the knock signal determined by means of a FFT (Fast Fourier Transform) analysis of the signal recorded on a reference detector:

C=Fₙ×D/αₙ,

where Fₙ. is the measured frequency corresponding to a natural vibration mode, D is the diameter of the cylinder and αₙ is the calculated coefficient relative to this vibration mode. For a chamber of simple shape, close to a cylindrical solid of revolution, coefficients αₙ can come from Bessel coefficients.

FIG. 1c shows the result of the FFT processing on recorded signal 1, F1 and F2 being the natural frequencies of the first two modes.

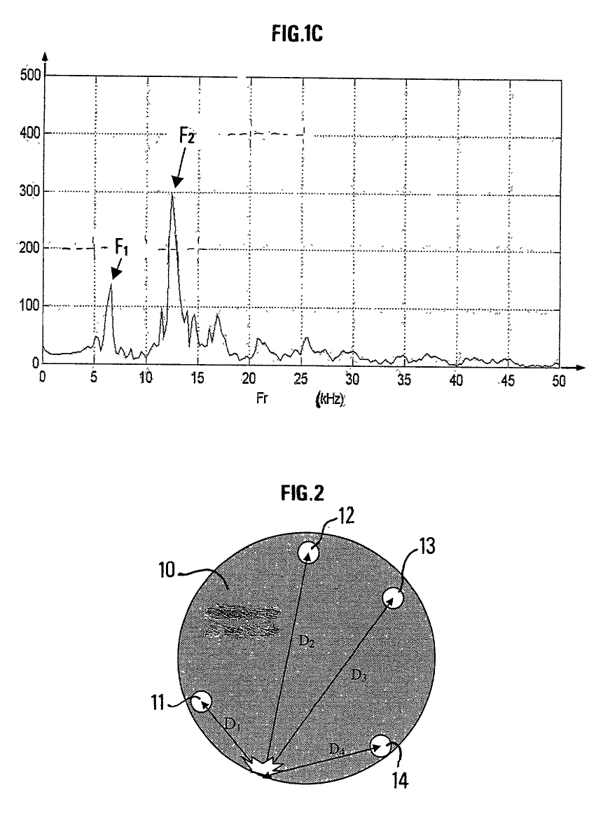

FIG. 2 shows the principle of installation of four pressure detectors 11, 12, 13, 14 in connection with a combustion chamber 10. These four detectors can be arranged on the same plane, for example the joint plane of the cylinder head. In another variant, at least one of the detectors is outside the plane defined by the three others. In another variant, the device comprises at least five detectors.

The difference between the emitter-receiver (knock source-detector) distances D is deduced for the various detectors, i.e. e1=D1−D2, e2=D1−D3 and e3=D1−D4, from the pressure wave arrival lag between the various detectors and the celerity. It is then possible to determine the origin of the knock in the combustion chamber by means of a triangulation method which consists in determining the point of intersection of the three hyperboloids of revolution having detectors (D1, D2; D1, D3; D1, D4) as the focus and differences e1, e2 and e3 as their parameters respectively.

The reconstruction accuracy will be markedly higher by multiplying the number of detectors, by determining with precision their response time and by increasing the temporal resolution of the acquisition.

It can be noted that the efficiency and the accuracy of the method will be all the 5 higher as the invention is applied in cases where the outset of the combustion to be located generates a relatively high pressure gradient.

1. A method of locating the source of a knock type self-ignition in a combustion chamber of an engine, characterized in that the following stages are carried out:
arranging several pressure detectors in said combustion chamber,
recording the pressure waves received by said detectors,
determining the velocity of propagation of the pressure waves in the chamber,
measuring the pressure wave arrival lag between the detectors,
determining the distance differences between the knock source and the various detectors, and deducing therefrom the spatial location of the knock source in the chamber.

2. A method as claimed in claim 1, wherein said pressure detectors are arranged in the joint plane of the cylinder head.

3. A method as claimed in any one of the previous claims, wherein at least one of the detectors is outside the plane defined by the other detectors.

4. A method as claimed in any one of the previous claims, wherein three detectors are used in cases where the knock appearance occurs in a known plane.

5. A method as claimed in any one of the previous claims, wherein at least four detectors are used.

6. Application of the method as claimed in any one of claims 1 to 5 to a sparg-ignition combustion engine.

7. Application of the method as claimed in any one of claims 1 to 5 to a homogeneous or heterogeneous diesel type charge compression combustion engine for determining the location of the self-ignition point.

8. Application of the method as claimed in any one of claims 1 to 5 to a controlled self-ignition combustion engine for determining the location of the self-ignition point.
